(19) United States
(12) Patent Application Publication
(10) Pub. No.: US 2024/0394864 A1
(43) Pub. Date: Nov. 28, 2024

(54) METHOD FOR DETERMINING WHETHER A PREDETERMINED GOOD TO BE TRANSPORTED IS ARRANGED IN A MONITORING REGION

(71) Applicant: 36ZERO VISION GMBH, Munich (DE)

(72) Inventor: Muhammad Zeeshan KARAMAT, Munich (DE)

(21) Appl. No.: 18/693,699

(22) PCT Filed: Sep. 20, 2022
(86) PCT No.: PCT/EP2022/076020

§ 371 Date: Mar. 20, 2024

(30) Foreign Application Priority Data
Sep. 21, 2021 (DE) 10 2021 124 348.3

(51) Int. Cl. G06T 7/00; G06N 3/045; G06N 3/088; G06V 10/82; G06V 20/64

(52) U.S. Cl. CPC G06T 7/0008; G06N 3/045; G06N 3/088; G06V 10/82; G06V 20/64; G06T 2207/20084

(57) ABSTRACT

The invention relates to a method for determining whether a predetermined transport item (1) is arranged in a monitoring area (2), wherein
an image signal of the monitoring area (2) through which a transport path of an object passes is acquired, wherein
before supplying the image signal to an artificial neural network (7), it is determined by another artificial neural network (19) on the basis of the image signal whether at least a part of an object is arranged in the monitoring area (2), wherein the image signal is supplied to the neural network (7) when it is determined by the other neural network (19) that at least a part of the object is arranged in the monitoring area (2), wherein
it is determined by the artificial neural network (7) on the basis of the image signal whether the determined at least one part of the object corresponds to at least a part of the predetermined transport item (1), wherein
when it is determined by the artificial neural network (7) that at least a part of the predetermined transport item (1) is arranged in the monitoring area (2), an image of the monitoring area (2) is generated.

The invention relates to a method for determining whether a predetermined transport item is arranged in a monitoring area. Furthermore, the invention relates to a computing device for determining whether a predetermined transport item is arranged in a monitoring area, and to a device having such a computing device. The invention also relates to a computer program product, a data carrier and a data carrier signal.

Various designs of production lines are known from the prior art. In the production lines, a predetermined transport item is examined at least once along a production route. In this regard, it is known from the prior art to provide devices by means of which the quality of the transport item is evaluated. These devices usually have an image acquisition device, by means of which an area of the production line is monitored. The image acquisition device is connected to the production line in terms of data transmission. In this way, sensor values relating to the position of the transport item are transmitted to the image acquisition device. This information is necessary so that at least one image of the monitoring area is captured when the transport item is actually arranged in the monitoring area. In this respect, a direct connection in terms of data transmission exists between the production line and the image acquisition device. The data can be transmitted via a data line or wirelessly.

A disadvantage of the known image acquisition devices is that the structure of the image acquisition device is very complex. In addition, a high setup effort is required in order to enable the image acquisition device to capture image signals of a monitoring area. Accordingly, it is very time-consuming and expensive to move the image acquisition device to another position on the production line, or this may not even be possible at all.

The object of the invention is to provide a method in which the disadvantages mentioned above do not occur.

The object is achieved by a method for determining whether at least one predetermined transport item is arranged in a monitoring area, wherein
an image signal of the monitoring area through which a transport path of an object passes is acquired, wherein
before supplying the image signal to an artificial neural network, it is determined by another artificial neural network on the basis of the image signal whether at least a part of an object is arranged in the monitoring area, wherein the image signal is supplied to the neural network when it is determined by the other neural network that at least a part of the object is arranged in the monitoring area, wherein
it is determined by the artificial neural network on the basis of the image signal whether the determined at least one part of the object corresponds to at least a part of the at least one predetermined transport item, wherein
when it is determined by the artificial neural network that at least a part of the at least one predetermined transport item is arranged in the monitoring area, an image of the monitoring area is generated.

A further object is to provide a computing device by means of which the disadvantages mentioned above can be avoided.

The device is implemented by a computing device for determining whether at least one predetermined transport item is arranged in a monitoring area, having
a transport item recognition module, which has an artificial neural network, and a filter module, which has another artificial neural network and is connected upstream of the transport item recognition module,
wherein the computing device is configured such that the other artificial neural network of the filter module determines whether at least a part of an object is arranged in the monitoring area on the basis of the image signal, wherein the image signal is supplied to the neural network of the transport item recognition module when the other neural network determines that at least a part of the object is arranged in the monitoring area, and that the artificial neural network determines on the basis of the image signal whether the determined at least one part of the object corresponds to at least a part of the at least one predetermined transport item, wherein
the computing device causes an image of the monitoring area to be generated when the artificial neural network determines that at least a part of the at least one predetermined transport item is arranged in the monitoring area.

According to the invention, it has been recognized that by providing an artificial neural network, it is no longer necessary for the computer unit in which the image signals are evaluated to be connected in terms of data transmission to a transport device by means of which the transport item is transported. In particular, a hardware connection between the image acquisition device and the transport device is no longer necessary. In the solution according to the invention, there is therefore no need for measured values ascertained by sensors of the transport device to be transmitted to the computing device. The computing device can determine, independently of the data ascertained by the transport device, whether at least a part of the transport item is arranged in the monitoring area and whether the determined transport item is a predetermined transport item. This makes it possible to place the computing device anywhere along the transport route without having to change any settings of the transport device. In addition, the method can be carried out with almost any image acquisition device, eliminating the need for complex image acquisition devices.

The filter module with the other neural network offers the advantage that not all image signals are supplied to the transport item recognition module. This is advantageous because the filter module can filter out image signals that do not contain a predetermined transport item. This means that they do not need to be analyzed by the transport item recognition module. As image signal processing by the transport item recognition module takes longer than by the filter module, the provision of the filter module ensures fast data processing.

The filter module is configured such that it recognizes whether at least a part of an object is arranged in the monitoring area. This also comprises the filter module recognizing that the entire object is arranged in the monitoring area. However, the filter module does not recognize what object it is. As such, the filter module does not recognize whether the object in question is the predetermined transport item.

The transport item recognition module is designed such that it recognizes whether the determined at least one part of the object corresponds to at least a part of the predetermined transport item. This also comprises recognizing whether the fully determined object corresponds to the predetermined transport item. The predetermined transport item is an object that is to be transported by means of the transport device and is therefore of interest. During operation, however, objects other than the predetermined transport item may be arranged on the conveyor belt and/or the image signal may contain other objects, such as people or moving components of the production line, which are not of interest. These objects must therefore be recognized as non-relevant objects and not taken into account.

A transport item is an object that is subjected to a spatial change of location by means of the transport device. The transport item is of interest to the user, so the method is intended to ascertain whether the transport item is arranged in the monitoring area. The transport device is used to transport the transport item and can be a conveyor belt, for example. Alternatively, other devices are also conceivable that act as a transport device.

In this context, “at least one predetermined transport item” is understood to mean that the computing device can determine a single predetermined transport item or multiple predetermined transport items. Multiple predetermined transport items can be items of the same type. Alternatively, the transport items can differ in type. In this case, the training process described below must be carried out for each transport item type so that they are recognized by the computing device as “predetermined transport items” during operation.

The transport path is the path along which the transport device transports the predetermined transport item or another object. In this regard, the monitoring area is selected such that it covers a part of the transport path. This constitutes a simple way of ensuring that the predetermined transport item always passes through the monitoring area during transportation.

The image generation or image capture is understood to be a process in which the image signal is stored in an electrical memory device at a specific point in time, in particular for repeated and/or permanent use. The electrical memory device can be a hard disk of the computing device and/or the image acquisition device. The image, which can be displayed, for example, can be generated based on the stored image signal. The image signal contains a large number of pixels that form the aforementioned image as a whole.

The computing device is a data-processing electrical unit by means of which the image signal is processed and/or evaluated. In this regard, the computing device can be a processor or have a processor.

The light of the image signal can be light that is visible to the human eye. The light can have a wavelength in the range between 380 nm and 780 nm (nanometers). This offers the advantage that no complex and expensive image acquisition device needs to be used to generate the image. In particular, an electrical device such as a cell phone, a tablet computer, a camera, etc. can be used to generate the image.

The artificial neural network and/or the other neural network can have been trained before operation. In addition, the data ascertained during the operation of the computing device can also be used to train the artificial neural network and/or the other neural network. The training processes are described in more detail below.

The neural network can be a network having at least an input layer and a decision layer. Furthermore, the neural network can have at least one layer. The neural network can, in particular, be a deep neural network. A deep neural network is an artificial neural network that has a plurality of layers. In particular, the neural network has the input layer and the decision layer. In between, the neural network has at least one layer that is connected to the input layer and the decision layer in terms of data transmission. The layer or layers arranged between the input layer and the decision layer are also referred to as the hidden layer or hidden layers. Every one of the aforementioned layers has neurons.

The neurons of one layer are connected to neurons of another layer. The connection can be such that a neuron of one layer is connected to all neurons of another layer. Alternatively, a neuron of one layer can be connected to only some of the neurons of the other layer. This allows a connection to be realized in the neural network in which one or more outputs of the input layer are supplied to the layer. In addition, one or more outputs of the layer are supplied to the decision layer.

In this regard, the neural network can have a convolutional neural network, also referred to as a convolutional neuronal network. A convolutional neural network is particularly suitable for examining image signals. In particular, patterns in image signals can be easily recognized using a convolutional neural network.

The image signal acquired by the image acquisition device can be supplied to an input layer of the convolutional neural network. In this regard, the number of neurons of an input layer of the convolutional neural network can correspond to a number of pixels of the image signal. The input layer thus contains information on the image height and image width. The input layer of the convolutional neural network can be three-dimensional. In this regard, the input layer can contain information on the image height, image width and image information. The image information can be color information, for example. In the event that the color information is limited to the colors red, yellow and blue, the input layer has three sub-layers.

The convolutional neural network can have one or more layers. The layer can be a neural convolutional layer and/or a layer following the input layer. The layer receives the output data from the input layer.

A layer can have multiple sub-layers. A sub-layer has a plurality of neurons arranged in a plane, wherein the planes are offset from one another. A layer can therefore be seen as a multi-dimensional matrix that outputs information at different levels of abstraction. As such, a first layer can recognize and output information about edges. The first layer can follow the input layer. A second layer following the first layer can recognize and output different shapes based on the edges. A third layer following the second layer can, in turn, recognize and output objects based on the different shapes. A fourth layer following the third layer can recognize and output structures based on the objects. As a result, the higher the number of layers, the more accurately the image signal can be analyzed.

As explained above, the convolutional neural network can have multiple layers, each having one or more sub-layers. The neural network can have a first layer and a second layer following the first layer, wherein the second layer is generated by applying a filter, in particular a one-dimensional or multi-dimensional filter. The filter is configured such that, when applied to the first layer, it generates a sub-layer of the second layer, in particular a single one. Thus, the filter is adapted to the first layer, in particular with regard to the number of sub-layers of the first layer. The number of sub-layers of the second layer can correspond to the number of filters applied to the first layer.

The first layer can follow the input layer and can be generated by applying a filter, in particular a one-dimensional or multi-dimensional filter. The filter is configured such that, when applied to the input layer, it generates a sub-layer of the first layer, in particular a single one. Thus, the filter is adapted to the input layer, in particular with regard to the number of sub-layers of the first layer. The number of sub-layers of the first layer depends on the number of filters applied to the input layer.

The decision layer of the neural network can be connected to at least two layers. This means that the outputs of at least two layers are supplied directly to the decision layer. In particular, the decision layer can receive the outputs from each layer directly. Alternatively, the decision layer can be directly connected to the input layer. This is the case when the neural network has no layer between the input layer and the decision layer.

The artificial neural network can have an unsupervised machine algorithm, in particular a learning algorithm. The unsupervised algorithm is used to precisely recognize whether the determined at least one part of the object corresponds to at least a part of the predetermined transport item.

An unsupervised algorithm is an algorithm that ascertains structures and relationships in the input data on the basis of inputs. In this context, a distinction can be made between two types of unsupervised learning algorithms. A “cluster” algorithm attempts to find clusters of observations in a data set that are similar to each other. An “association” algorithm attempts to find rules with which associations can be drawn. It is particularly advantageous if the unsupervised algorithm is a proximity search algorithm, in particular a nearest-neighbor algorithm.

A decision layer of the convolutional neural network can have the unsupervised learning algorithm. Thus, the unsupervised learning algorithm is supplied with the output data of the layer or the input layer. The decision layer and thus the unsupervised algorithm can be fully connected to the preceding layer or the input layer. In particular, all neurons of the decision layer are connected to all neurons of the preceding further layer or the input layer. The convolutional neural network can have only a single layer, in particular the decision layer, which is fully connected to the preceding layer. The preceding layer is understood to be the layer that is arranged before the decision layer in an information flow from the input layer to the decision layer.

The decision layer can have a plurality of neurons that extend, in particular exclusively, in one direction. Such a one-dimensional decision layer enables faster processing of the data.

In actual operation, a data element of the image signal that is supplied to the decision layer can be evaluated in order to determine whether it contains a part of the predetermined transport item. In this regard, the evaluation can include the determination of at least one parameter of the supplied data element. In particular, two parameters can be determined. The parameters can differ in type. For example, one parameter can be the variance of image information contained in the data element and/or another parameter can be the expected value of image information contained in the data element. Using the unsupervised learning algorithm and the at least one determined parameter, in particular the two determined parameters, it can be determined whether the data element contains a part of the predetermined transport item.

The unsupervised learning algorithm can use a training result in order to determine whether the data element contains a part of the predetermined transport item. The training result can be at least one parameter range. In particular, the training result can be two parameter ranges. This is relevant for the case when the unsupervised learning algorithm determines two parameters. The parameter range ascertained during training is referred to below as the pre-trained parameter range.

The unsupervised learning algorithm can determine that the supplied data element contains a part of the predetermined transport item if the determined at least one parameter is within the at least one pre-trained parameter range. In the case where two parameters are determined, the unsupervised learning algorithm determines that the supplied data element contains a part of the predetermined transport item if a first determined parameter, such as the variance, is within a first pre-trained parameter range and a second determined parameter, such as the expected value, is within a second pre-trained parameter range. It has been recognized that by using the unsupervised learning algorithm, it is possible to determine whether the objects contained in the image signal correspond to the predetermined transport item. The neural network can therefore be used in a flexible manner. In particular, the neural network can also be used if the image signal contains objects that are not known to the neural network. This is possible because the unsupervised learning algorithm refers to the at least one parameter and uses the at least one parameter to determine whether the image signal contains the predetermined transport item or not.

Depending on the training process, the unsupervised learning algorithm can be trained to also determine another predetermined transport item. In other words, the method works in the same way if multiple predetermined transport items are to be determined. The other transport item differs, for example, in type from the predetermined transport item. In this case, both transport item types can be arranged in the monitoring area at the same time. Alternatively, the transport item types can be arranged in the monitoring area at different points in time.

In this case, multiple parameter ranges of the same type will have been determined during the training process, which are assigned to the respective transport item. This means that if the parameter ascertained in actual operation is within the predetermined parameter range, the computing device can determine the predetermined transport item assigned to the predetermined parameter range. As a result, the neural network can be used to easily recognize whether a predetermined transport item or multiple predetermined transport item types are arranged in the monitoring area.

In a particular embodiment, the unsupervised algorithm can be configured such that it outputs a bounding box which encloses the part of the predetermined transport item. In particular, a bounding box can be generated when it has been determined that a part of the predetermined transport item is arranged in the monitoring area. The bounding box is determined based on the analysis of the data elements described above. As such, after analyzing the data elements, those data elements are known that contain a part of the transport item.

The advantage of using a convolutional neural network having an unsupervised learning algorithm is that it is particularly good at recognizing whether the predetermined transport item is arranged in the monitoring area.

In a particular embodiment, the computing device can have a trigger module that determines a capture time. The trigger module can be connected downstream of the transport item recognition module in terms of data transmission. This means that the trigger module receives the output data from the transport item recognition module as input data. Alternatively, it is possible for the trigger module to work in parallel with the transport item recognition module.

In this context, the capture time corresponds to the time at which the image is captured. The capture time can be offset by a period of time from a determination time at which the other artificial neural network has determined that at least a part of the object is arranged in the monitoring area. Alternatively, it is possible that the capture time is not offset in time in relation to the capture time and thus an image is captured at the same time at which it was determined that the object is arranged in the monitoring area. In this case, the other artificial neural network determined that the object, in particular the transport item, is arranged in the monitoring area in its entirety.

In the event that it is determined that only an object part, in particular a transport item part, is arranged in the monitoring area, the period of time can be selected such that the entire object, in particular the transport item, is arranged in the monitoring area at the capture time. This means that the image is only captured when the object, in particular the transport item, moves from the position at the determination time to a position in which the object, in particular the transport item, is arranged in the monitoring area in its entirety. As a result, the trigger module makes a prediction as to when the transport item is arranged in the monitoring area in its entirety. This is a simple way of ensuring that only images that can actually be processed as part of the subsequent processing are captured. This requires the entire transport item to be arranged in the monitoring area.

The capture time can be determined and/or the image can be generated only when the neural network of the transport item recognition module determines that the determined object corresponds to the at least one predetermined transport item.

An algorithm of the trigger module can be used to determine when the object, in particular the transport item, is arranged in the monitoring area in its entirety. The trigger module can have a linear quadratic estimation algorithm, which is used to determine when the transport item is arranged in the monitoring area in its entirety.

The trigger module thus takes into account the fact that the image acquisition device requires a certain amount of time from receipt of a capture signal to acquire an image. Accordingly, the trigger module ensures that the image acquisition device acquires the image neither too early nor too late, but always when the predetermined transport item is arranged in the monitoring area in its entirety.

The captured image can be processed such that the transport item quality can be assessed in a subsequent step. In particular, it is possible to assess whether the transport item has any damage and/or is subject to other undesirable properties. As a result, an image can be provided in a simple way and without a connection to the transport device in terms of data transmission, which can be used to assess the transport item quality. This means that no electrical data, such as sensor data, relating to a status and/or a property of the transport device and/or the transport item is transmitted to the computing device. The determination of the transport quality can thus be based solely on the acquired optical image signal.

As already explained above, the computing device has a filter module. The filter module is configured such that it evaluates the image signal before supplying it to the artificial neural network in order to determine whether at least a part of the object is arranged in the monitoring area. In this regard, the filter module is provided in the computing device such that it receives the image signals acquired by the image acquisition device first. The filter module can thus filter out image signals so that only some of the image signals originating from the monitoring area are supplied to the transport item recognition module. This is advantageous because the filter module requires less computing power than the modules downstream of the filter module. This means that the required computing power can be kept low if no object is arranged in the monitoring area.

The filter module can have another artificial neural network. The other artificial neural network can determine whether an object is arranged in the monitoring area based on the supplied image signal. The other artificial neural network can be a deep neural network. The other artificial network can have fewer layers than the artificial neural network. This allows the other artificial network to process the image signal faster than the artificial neural network.

In addition, the other neural network can be another convolutional neural network. As described above, the other convolutional neural network has the advantage of being able to recognize image patterns and is therefore advantageous for the analysis of image signals. As a result, the other artificial neural network differs from the artificial network in that it is optimized for fast processing of the image signals and recognizes that at least a part of the object is arranged in the monitoring area. However, it usually does not recognize, or does not recognize at all, which specific object is arranged in the monitoring area. In contrast, the artificial neural network is optimized to recognize whether the object in the monitoring area corresponds to the predetermined transport item.

The image signal acquired by the image acquisition device can be supplied to an input layer of the other artificial neural network. In this regard, the number of neurons of the input layer of the other convolutional neural network can correspond to a number of pixels of the image signal. The input layer thus contains information on the image height and image width. The input layer of the other convolutional neural network can be three-dimensional. In this regard, the input layer can contain information on the image height, image width and image information. The image information can be color information, for example. In the event that the color information is limited to the colors red, yellow and blue, the input layer has three sub-layers. As a result, the input layer of the other neural network can be identical to the input layer of the neural network described above.

The other convolutional neural network can have one or more further layers. The further layer can be a neural convolutional layer and/or a layer following the input layer. The further layer receives the output data from the input layer. At least one filter with a predetermined pixel size of the further layer analyzes the received data and outputs an output matrix. The number of output matrices depends on the number of filters. The size of the output matrix depends on the filter size and other factors such as the padding and the step size. In addition, the output of the further layer can be simplified, in particular reduced, by pooling.

As described above, the number of further layers of the other convolutional neural network is smaller than the number of layers of the convolutional neural network. As such, the other convolutional neural network can have only one input layer and one output layer. Alternatively, the other neural network can have one or more layers between the input layer and the output layer. As such, the other neural network can have 10 or fewer further layers. In contrast, the convolutional neural network can have 20 or more further layers.

The other artificial neural network can have another unsupervised machine algorithm, in particular a learning algorithm. The other unsupervised algorithm is used to recognize whether at least a part of an object is arranged in the monitoring area. In particular, the other unsupervised algorithm also recognizes a previously unknown object arranged in the monitoring area. It is particularly advantageous if the other unsupervised algorithm is a proximity search algorithm, in particular a nearest-neighbor algorithm.

A decision layer of the other convolutional neural network can have the other unsupervised learning algorithm. Thus, the other unsupervised learning algorithm is supplied with the output data of a further layer or the input layer. The decision layer and thus the other unsupervised algorithm can be fully connected to the preceding further layer or the input layer. In particular, all neurons of the decision layer are connected to all neurons of the preceding further layer or the input layer. The other convolutional neural network can have only a single layer, in particular the decision layer, which is fully connected to the preceding layer or the input layer. The preceding layer is understood to be the layer that is arranged before the decision layer in an information flow from the input layer to the decision layer.

The other unsupervised learning algorithm can be configured to output information as to whether a part of the object is arranged in the monitoring area or not. If the unsupervised learning algorithm determines that a part of the object is arranged in the monitoring area, the image is supplied to the neural network. As a result, the image signals are filtered in a simple way so that the neural network is only supplied with the image signals in which at least a part of the object is arranged in the monitoring area. The neural network can then determine in the manner described above whether the determined object is the predetermined transport item and/or generate the bounding box.

The other unsupervised learning algorithm can use a training result from the other neural network in order to determine whether the data element of the image signal contains a part of the object. This allows the other unsupervised learning algorithm to determine another parameter based on the image signal. Depending on the other parameter, the unsupervised learning algorithm can determine whether at least a part of the object is arranged in the monitoring area. In particular, another parameter or another parameter range pre-trained in the training process can be used to assess whether the data element contains a part of the object or not. As such, by comparing the other parameter determined in actual operation with the other parameter or other parameter range pre-trained in the training process, it is possible to determine whether the data element contains at least a part of the object.

This allows for an evaluation as to whether the other parameter is within the pre-trained other parameter range. If this is the case, the other neural network recognizes that at least a part of an object is arranged in the monitoring area. As a result, the other neural network works like the neural network in that, in both cases, an evaluation is performed as to whether another parameter ascertained in actual operation is within a pre-trained other parameter range, wherein the output of the respective network depends on the evaluation result. Therefore, reference is also made to the above explanations pertaining to the neural network.

As described above, the two networks can differ in the number of layers. In particular, the other neural network can have fewer layers than the neural network, so that the other neural network cannot recognize exactly which object it is. However, the other neural network can accurately recognize whether at least a part of the object is arranged in the monitoring area. As a result, the neural network outputs whether the object in question is the predetermined transport item or a part of the transport item, while the other neural network outputs whether any part of an object is arranged in the monitoring area at all.

The structure, in particular the connections between the different layers, of the other artificial neural network can be ascertained by a neural architecture search system. This can also be done during the training process. In this regard, the structure of the network is optimized for speed and not for the precise recognition of patterns. A system structured in this way offers the advantage that the image signal can be examined particularly quickly.

In artificial neural networks, every neuron of one layer is connected to every neuron of another layer. The search system is designed such that it recognizes which connections between the neurons are actually necessary and removes those that are not. Therefore, the search system reduces the number of connections between the neurons, allowing the artificial neural network to process the image signal quickly. Since the decision layer is fully connected to the preceding layer, optimization only takes place in the layers preceding the decisions.

The convolutional neural network is trained as part of a training process before it is used. The training of the neural network can have a first training phase and a second training phase, in particular following the first training phase. The training of the neural network in the second training phase can be carried out using the neural network trained in the first training phase. This is explained in more detail below.

In the first training phase, the neural network can be modified in comparison with the neural network used in actual operation, such that the neural network to be trained has a different decision layer. In particular, the decision layer of the network to be trained does not have an unsupervised learning algorithm. This means that in the first training phase, the layers of the neural network to be trained that precede the decision layer are trained.

Training is carried out in the first training phase with training images. The number of training images supplied to the neural network to be trained in the first training phase is greater than the number of images supplied to the neural network to be trained in the second training phase. The images supplied to the neural network to be trained are labeled. The first training phase can be understood as a basic training of the neural network. This means that the training is not focused on the specific use case, i.e., the at least one predetermined transport item, but the objective is for the neural network to learn a large number of different objects.

The term “labeled” means here that the image signal contains information on the image height, image width and other image information, such as the color. In addition, the image signal contains information about the objects portrayed in the images. In particular, the image signal contains information about what objects are involved, for example screws, a chair, a pen, etc. In this context, the training images supplied during the first training phase can include the predetermined transport item. The labeled or classified objects are at least partially enclosed by a bounding box so that the convolutional neural network recognizes where the predetermined transport item is arranged in the image signal.

In the first training process, the neural network to be trained is supplied with a large number of images, in particular, for example, millions of images, which, as explained above, contain information about the object and the position of the object. As described above, the images can show a variety of different objects, wherein the transport item may or may not be included in the images.

The first training phase can preferably be carried out only once. In this case, the neural network is only trained according to the second training phase for each new use case. Alternatively, the first training phase can be carried out before each second training phase, in particular every time the neural network is used in a new use case.

In the second training phase, the decision layer of the neural network to be trained has the unsupervised learning algorithm. This means that the neural network to be trained in the second training phase corresponds in structure and function to the neural network that is used in actual operation. In the second training phase, the neural network trained in the first training phase is used. This means that in the second training phase, the layer or layers preceding the decision layer have already been trained. The second training phase is used to train the neural network for the specific use case, i.e., for the case in which the neural network is to recognize the at least one transport item.

For training, the neural network to be trained can be supplied with training images that contain the predetermined transport item and possibly one or more other objects, as well as training images that contain no object and thus no predetermined transport item. However, it is advantageous if 20-100%, in particular 80-95%, preferably 90-95%, of the supplied training images portray the predetermined transport item. In the second training phase, the same training images can be supplied as in the first training phase. Alternatively, different training images can be supplied. In this regard, at least one training image, in particular a plurality of training images, can be supplied to the neural network in the second training phase. Also in this context, some of the training images may be labeled and some of the training images may not be labeled. Alternatively, all images can also be unlabeled. In this regard, all training images containing an object are labeled. Training images that do not contain an object are not labeled.

After the second training phase, the neural network is trained with respect to the at least one predetermined transport item. This means that the neural network recognizes very precisely whether the object in the monitoring area is the predetermined transport item. Accordingly, the output of the neural network is whether the object in the monitoring area is the predetermined transport item.

In this regard, at least one parameter is determined for a training data element supplied to at least one neuron of the decision layer. This can be done in the second training phase because, as explained above, the neural network is trained with respect to the predetermined transport item in the second training phase. The training data element originates from a layer preceding the decision layer. The training data element contains image information, in particular an image intensity, and/or represents an image area of a training image. The decision layer is supplied with a plurality of training data elements, each representing an image area. As a result, the complete image is available to the decision layer in the form of training data elements. It shall be understood that for each training image supplied to the neural network to be trained, the training data elements are supplied to the decision layer.

In the decision layer, at least one parameter, in particular two parameters, is/are ascertained for the training data elements, in particular all training data elements, of a training image. In particular, a variance of the image information contained in the training data element is determined as the first parameter and/or an expected value, in particular a normal distribution, of the image information contained in the training data element is determined as the second parameter.

In this regard, a parameter range can be determined, taking into account the at least one determined parameter, in which the training data element has a part of the transport object. The parameter range can be ascertained because a large number of training images are used for training. Accordingly, many parameters are determined so that a parameter range can be ascertained. In the event that two parameters are determined, two parameter ranges assigned to the predetermined transport item are determined. In this regard, the training data element has at least a part of the transport item if both ascertained parameters are within the respective parameter range.

This makes use of the circumstance that the layers trained in the first training phase can ascertain very accurately whether the image signal contains an object. It is therefore possible in the second training phase that at least one cluster, in particular parameter ranges, can be formed. In the second training phase, the unsupervised algorithm is not adapted, but the parameter(s) mentioned above is/are determined. Thus, after completion of the second training phase, the parameter values or parameter value ranges are known, which define a cluster range in which training data elements of the training images are arranged, which contain a part of the transport item. With knowledge of the parameter values or the parameter value ranges, a decision can be made in actual operation as to whether the image signal contains at least a part of the transport item.

The other neural network, in particular the convolutional network, is trained as part of a training process before it is used. The training can be identical to that of the neural network. This means that the other neural network can also be trained in two training phases. Analogous to the neural network, at least one other parameter can be determined during training for a training image supplied to the decision layer of the other neural network. In this regard, the other unsupervised learning algorithm can determine the other parameter or another parameter range. The determined and pre-trained other parameter or other parameter range can characterize whether at least a part of the object is arranged in the monitoring area. As such, in actual operation, the ascertained other parameter can be compared with the pre-trained parameter or pre-trained other parameter range determined in the training process and, depending on the comparison, it can be determined whether at least a part of the object is arranged in the monitoring area. In particular, it can be determined that at least a part of the object is arranged in the monitoring area if the determined other parameter is within the pre-trained other parameter range. In contrast to the neural network, the other neural network is trained such that the output of the other neural network is whether at least a part of the object is arranged in the monitoring area or not.

Of particular advantage is a device having an image acquisition device for acquiring an image signal which originates from a monitoring area and a computing device according to the invention which is connected to the image acquisition device in terms of data transmission. The image acquisition device and the computing device are connected such that the image signals acquired by the image acquisition device are supplied to the computing device.

The image acquisition device and the computing device can be integrated in the same device. For example, the device can be a cell phone or camera or tablet computer or the like. Alternatively, the image acquisition device and the computing device can be formed separately from one another. For example, the computing device can be part of a computer that is connected to the image acquisition device in terms of data transmission. Thus, in contrast to the known devices, the computing device needs to communicate with the image acquisition device and not with the transport device.

The image acquisition device can have a lens. In this regard, the same image acquisition device can acquire the image signal originating from the monitoring area as well as capture and thus generate the image. Alternatively, one image acquisition device can acquire the image signal originating from the monitoring area and another image acquisition device can capture and thus generate the image. The image acquisition device can continuously monitor the monitoring area so that image signals are continuously acquired by the image acquisition device. Accordingly, image signals are continuously evaluated by the computing device. The image acquisition device can be designed such that it can acquire image signals that lie in the wavelength range visible to the human eye. Alternatively or in addition, the image acquisition device can be designed such that it can process image signals that lie outside of the wavelength range visible to the human eye, in particular in the infrared or hyperspectral range.

As described above, the computing device can output a capture signal and transmit it to the image acquisition device. The image acquisition device can capture and thus generate the image after receiving the capture signal at the capture time. The capture signal can contain information pertaining to the capture time or is output at the capture time.

Of particular advantage is a computer program which comprises instructions which, when the program is executed by a computer, cause the computer to carry out the method according to the invention. A data carrier on which the computer program according to the invention is stored is also advantageous. In addition, a data carrier signal is advantageous which transmits a computer program according to the invention.

The subject matter of the invention is shown schematically in the figures, wherein elements that are the same or have the same effect are usually provided with the same reference symbols. In the figures:

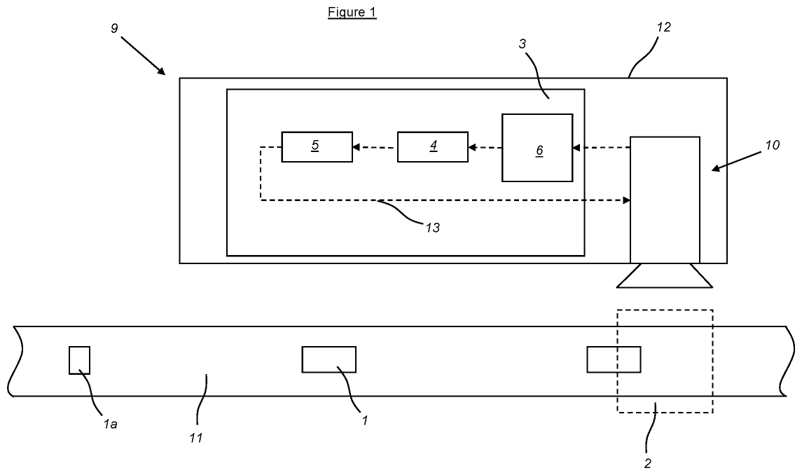

FIG. 1 shows a schematic representation of a device according to the invention at a time when a part of a predetermined transport item is arranged in a monitoring area in its entirety,

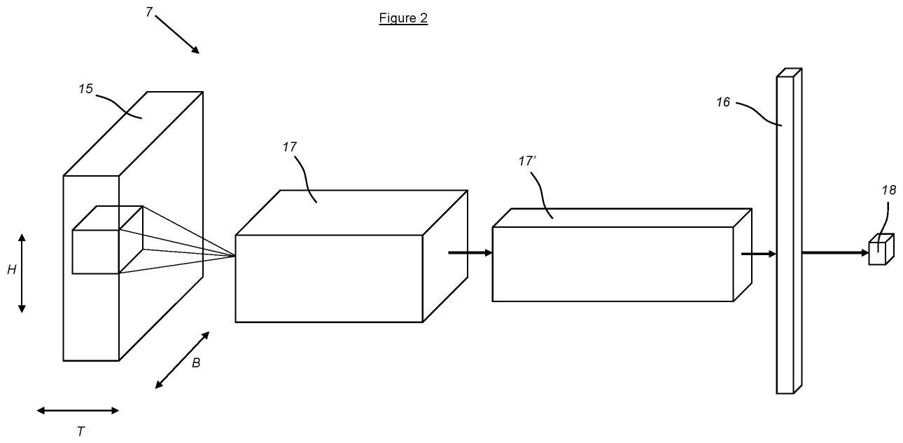

FIG. 2 shows a schematic representation of an artificial neural network,

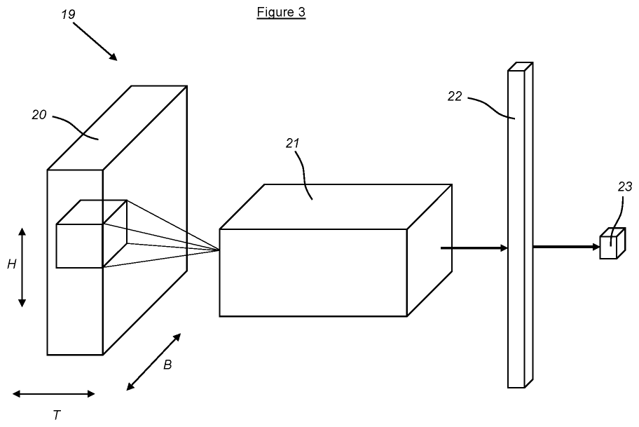

FIG. 3 shows a schematic representation of another artificial neural network,

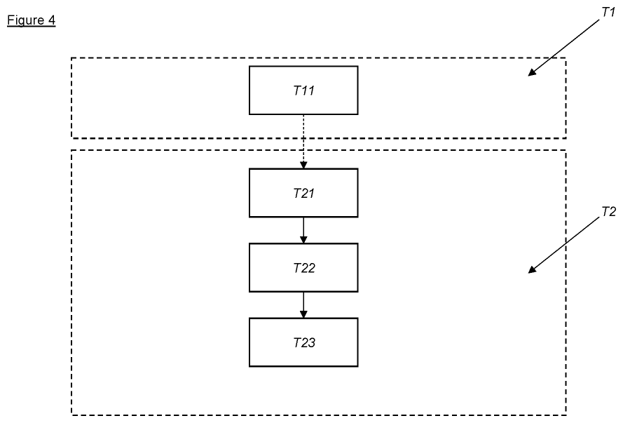

FIG. 4 shows a flow chart of a training of the artificial neural network from FIG. 2,

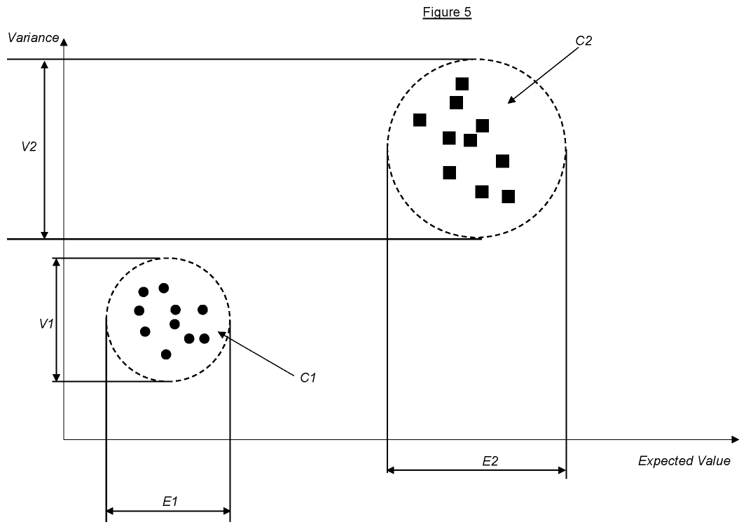

FIG. 5 shows a distribution of training data elements, and

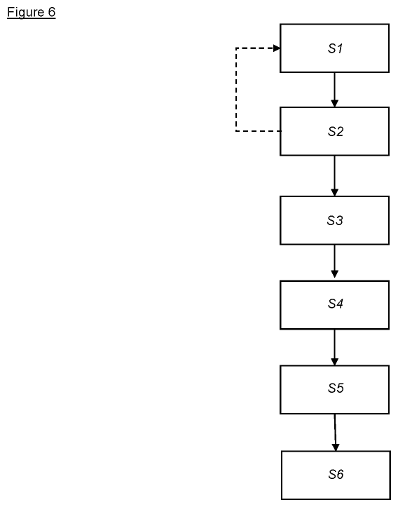

FIG. 6 shows a flow chart of the method according to the invention.

A device 9 shown in FIG. 1 has an image acquisition device 10 and a computing device 3. Here, at least a part of the image acquisition device 10 and the computing device 3 are arranged in a cavity of the device 9 enclosed by a housing 12. The image acquisition device 10 and the computing device 3 are connected in terms of data transmission. In this way, optical image signals acquired by the image acquisition device 10 are transmitted to the computing device 3. The device 9 can be a cell phone. As can be seen from FIG. 1, the device 9 is not connected to the transport device 11 in terms of data transmission. This means that there is no data exchange between the transport device 11 and the device 9. In particular, no data is transmitted from the transport device 11 to the device 9 or vice versa.

The image acquisition device 10 monitors a monitoring area 2 from which the image signal originates. The transport device 11 can be a conveyor belt or the like. In this regard, the transport device 11 is used to transport objects. The object can be a predetermined transport item 1, which is analyzed further. Alternatively, the object can be another transport item 1a, which is not relevant and should therefore not be analyzed further.

The image acquisition device 10 is positioned such that the monitoring area 2 comprises an area of the transport device 11. In particular, the monitoring area 2 comprises a transport path of the object, so that it is ensured that every predetermined transport item 1 and every other, non-relevant transport item 1a must pass through the monitoring area 2. In the case shown in FIG. 1, a part of the predetermined transport item 1 is arranged in the monitoring area 2. The image acquisition device 10 can capture an image of the monitoring area 2 after receiving a capture signal 13 output by the computing device 3.

The computing device 3 comprises a filter module 6 to which the image signal acquired by the image acquisition device 10 is supplied. Furthermore, the computing device 3 has a transport item recognition module 4 to which an output signal from the filter module 6 can be supplied. The transport item recognition module 4 has an artificial neural network, the structure of which is shown in FIG. 3. The filter module 6 has another artificial neural network, the structure of which is shown in FIG. 3. The computing device 3 also has a trigger module 5. The output signal of the filter module 6 is supplied to the transport item recognition module 4 and the trigger module 5.

The transport item recognition module 4 and the trigger module 5 generate the capture signal 13, which is supplied to the image acquisition device 10. The image acquisition device 10 captures an image of the monitoring area 2 after receiving the capture signal 13. The image is stored and can be used to subsequently determine the quality of the predetermined transport item 1.

In the embodiment shown in FIG. 1, the trigger module 5 is connected downstream of the transport item recognition module 4.

FIG. 2 shows a schematic structure of an artificial neural network 7 of the transport item recognition module 4.

The neural network 7 has an input layer 15 and a decision layer 16, as well as a plurality of layers 17, 17′. Although two layers are shown in FIG. 2, namely a first layer 17 and a second layer 17′, the neural network 7 has more than two layers 17, 17′. The information flow from the input layer 15 to the decision layer 16 occurs in the direction indicated by the arrow. As such, the neural network 7 can have more than 100 layers.

As explained in more detail below, the image signal received by the filter module 6 from the image acquisition device 10 is transmitted to the transport item recognition module 4 when it is determined in the filter module 6 that at least a part of the predetermined transport item 1 is arranged in the monitoring area 2.

In this case, the image signal is supplied to the input layer 15 of the neural network 7. The input layer is three-dimensional. The extension of the input layer 15 in the width direction W corresponds to an image width and the extension of the input layer 15 in the height direction H corresponds to the image height. The in number of neurons of the input layer 15 not shown in FIG. 2 can correspond in the width direction W to the number of pixels contained in the image signal in the width direction W and in the height direction H to the number of pixels contained in the image signal in the height direction. The input layer 15 can contain further image information in the depth direction D. As such, the input layer 15 can contain color information in the depth direction D. In the case that only the colors red, yellow and blue are considered, the input layer has three sub-layers in the depth direction D, not shown in FIG. 2, namely one sub-layer for each of the aforementioned colors. However, the image information is not limited to the color.

The layers 17 are convolutional layers. The layers 17 each have multiple filters, which leads to a greater extension of the layers 17 in the depth direction D. This means that the layers 17 have a greater number of sub-layers in the depth direction D than the input layer 15 and/or than the respective preceding layer 17, 17′. In addition, the filters are selected such that the number of neurons is reduced, at least in the width direction W. In this context, the number of neurons in the width direction W can decrease further from the layer 17, 17′ to the further layer 17, 17′ in the direction of the decision layer 16. In particular, the neural network 7 is designed such that the decision layer 16 is one-dimensional. In the case shown in FIG. 2, the decision layer 16 thus extends in the height direction H.

The decision layer 16 has an unsupervised learning algorithm. The unsupervised learning algorithm can be a proximity search algorithm, in particular a nearest-neighbor algorithm. The decision layer 16 is fully connected to the preceding layer 17. This means that all neurons of the preceding layer 17 are connected to all neurons of the decision layer 16. The convolutional neural network 7 has only one layer, namely the decision layer 16, which is fully connected to a preceding layer.

The unsupervised learning algorithm is configured such that its output 18 contains information as to whether at least a part of the object, in particular the transport item 1, 1a in the monitoring area 2 corresponds to at least a part of the predetermined transport item 1. In addition, the unsupervised learning algorithm generates a bounding box which encloses the transport item or a part of the transport item.

FIG. 3 shows a schematic structure of another artificial neural network 7 of the filter module 6.

The other neural network 19 has an input layer 20 and a decision layer 22 as well as a plurality of further layers 21. Although one further layer 21 is shown in FIG. 3, the neural network 19 can have more than one layer 21. However, the other neural network 19 has fewer further layers 21 than the neural network 7 shown in FIG. 2. The information flow from the input layer 15 to the decision layer 16 occurs in the direction indicated by the arrow.

The image signal acquired by the image acquisition device 10 is supplied to the input layer 20. The input layer is designed to be three-dimensional and identical to the input layer 15 of the neural network 7. Therefore, reference is made to the above explanations.

The decision layer 22 has an unsupervised learning algorithm. The unsupervised learning algorithm can be a proximity search algorithm, in particular a nearest-neighbor algorithm. The unsupervised learning algorithm can be configured such that its output 23 contains information as to whether at least a part of the object is arranged in the monitoring area 2. In this context, the filter module does not differentiate whether the determined object is the predetermined transport item or not. The filter module 6 only ascertains that a transport item 1 or another transport item 1a or another object is arranged in the monitoring area.

FIG. 4 shows a flow chart of a training of the neural network 7 shown in FIG. 2. The training has two training phases T1, T2, wherein the second training phase T2 follows the first training phase T1. In the first training phase T1, a neural network based on the neural network shown in FIG. 2 is trained. The neural network to be trained differs in the decision layer 16 from the neural network shown in FIG. 2. As such, the decision layer 16 of the neural network to be trained does not have an unsupervised learning algorithm, but instead outputs the result ascertained in the preceding layers. The output can contain information as to whether a part of the predetermined transport item 1 is arranged in the monitoring area 2 and/or comprise a bounding box enclosing the part of the transport item 1 in the monitoring area.

In a first training step T11 of the first training phase, a plurality of training images are supplied to the input layer. The training images can be labeled and, in particular, all training images are labeled. In particular, the images contain information as to whether an object is arranged and/or where the object is arranged. In this regard, the training images can contain the predetermined transport item 1. The training images can also contain other objects in addition to the predetermined transport item. It is also possible that the training images do not contain the predetermined transport item 1. As a result, the training images contain a large number of different objects.

The neural network 7 to be trained is supplied with a large number of training images. The objective of the first training phase is a basic training, after which the neural network recognizes a large number of objects, which can also include the at least one predetermined transport item. After completion of the first training process, the layers 17, 17′ of the neural network can already precisely recognize whether a part of an object is arranged in the image signal.

After completion of the first training phase T1, the second training phase T2 is initiated. The second training phase is based on the neural network T1 trained in the first training phase T1, which is symbolized by the dashed arrow in FIG. 4. The second training phase is used to train the neural network for the specific use case. This means that once the second training phase has been completed, the neural network can easily recognize whether the object in the monitoring area is the predetermined transport item.

The neural network to be trained in the second training phase T2 does not differ in structure and function from the neural network used in actual operation, which is shown in FIG. 2. In other words, the neural network to be trained in the second training phase T2 has a decision layer 16 with the unsupervised learning algorithm. In addition, the neural network to be trained in the second training phase T2 has the layers 17, 17′ trained in the first training phase T1.

In a first training step T21, the neural network 7 to be trained is supplied with images that contain a predetermined transport item and images that do not contain a predetermined transport item. In contrast to the first training phase T1, at least some of the images are not labeled or all images are not labeled.

In a second training step T22, multiple parameters are ascertained in the decision layer 16 for each training data element of the training image supplied to the decision layer. The training data element represents a part of the training image and contains at least one piece of image information, such as the light intensity. In the second training step T22, a normal distribution is then ascertained for the image information contained in the training data element. In particular, a variance and/or an expected value of the normal distribution is ascertained. The parameters are determined for each training data element of a training image. In addition, the process is repeated for each training image supplied to the neural network to be trained, in particular the training data elements of the training image.

In a third training step T23, based on the ascertained parameter values, at least one parameter range is determined, in which training data elements, containing at least a part of the transport item 1, lie. Accordingly, it is also known for which parameter values the training data elements do not contain any part of the predetermined transport item. This makes use of the circumstance that the layers 17, 17′ can already accurately ascertain whether an image signal contains a part of the predetermined transport item 1. Since the image information of a training data item and thus the parameters depend on whether it contains a part of the predetermined transport item, the training data items can be classified using the ascertained parameters as to whether they contain a part of the predetermined transport item 1 or not.

FIG. 5 shows a diagram with training data elements. Here, the vertical axis is a parameter, such as the variance, of the image information contained in the training data element and the horizontal axis is another parameter, such as the expected value, of the image information contained in the training data element. The training data elements shown in FIG. 5 show the same image section in each of the training images supplied to the neural network 7. In the present case, it was assumed that the neural network 7 is supplied with 20 training images, wherein 10 training images contain a first predetermined training item and 10 training images contain a second predetermined training item.

In the exemplary embodiment shown in FIG. 5, it is assumed that the neural network is trained such as to recognize two predetermined different transport items. As part of the training process, two parameter ranges, also referred to as cluster ranges C1 and C2, are identified. A first cluster range is defined by a first expectation range E1 and a first variance range V1. A second cluster range is defined by a second expectation range E2 and a second variance range V2. The cluster ranges are determined by means of the ascertained parameter values of the first predetermined transport item and by means of the ascertained parameter values of the second predetermined transport item. Here, the first cluster range is selected such that the parameter values determined by the neural network for the first predetermined transport item lie within the cluster range. In addition, the second cluster range is selected such that the parameter values determined by the neural network for the second predetermined transport item lie within the second cluster range C2.

The other neural network 19 shown in FIG. 3 is trained in the same way as the neural network 7. In this respect, reference is made to the above explanations pertaining to FIGS. 4 and 5. In contrast to the neural network 7, however, the other neural network 19 outputs information as to whether at least a part of the object is arranged in the monitoring area 2.

The method for determining whether a predetermined transport item 1 is arranged in a monitoring area 2 is described in more detail in FIG. 6. FIG. 6 shows a flow chart of the method according to the invention.

In a first method step S1, an image signal originating from the monitoring area 2 is acquired by the image acquisition device 10. The acquired image signal is supplied to the filter module 6. The filter module 6 is used to determine whether at least a part of the transport item 1 is arranged in the monitoring area 2. The filter module 6 has the other artificial neural network 19, which can be a convolutional neural network. The convolutional neural network has already been trained before use.

In a second method step S2, the other artificial network 19 determines whether at least a part of an object is arranged in the monitoring area 2 on the basis of the image signal received from the image acquisition device 10. In particular, it is determined whether the ascertained other parameter value is within the other pre-trained parameter range. If it is determined in the filter module 6 that no object part is arranged in monitoring area 2, processing is ended and the method sequence starts anew. This is the case if the ascertained other parameter value is not within the other pre-trained parameter range. This is symbolized by the dashed arrow. As the filter module 6 continuously receives image signals from the image acquisition device 10, a new image signal is examined in the filter module 6 as described above.

In the event that the output of the filter module 6 is that a part of the object is arranged in the monitoring area 2, the output signal is transmitted from the filter module 6 to the transport item recognition module 4 in a third method step S3. In the transport item recognition module 4, the image signal originating from the filter module 6 is processed in the layers 17, 17′. In the process, multiple data elements of the image signal are transmitted to the decision layer 16. In the decision layer, the parameters mentioned above, such as the variance and expected value, are determined for each data element. As explained above, each data element represents a part of the image signal. In other words, the image signal is supplied to the decision layer in the form of data elements.

The unsupervised learning algorithm then determines for each data element whether the data element is in the first cluster range C1 or the second cluster range C2 based on the ascertained parameter values. If this is the case, the transport item recognition module determines that it is a predetermined transport item assigned to the cluster range C1, C2 or at least a part of the predetermined transport item. This process is repeated for all data elements of the image signal.

In a fourth method step S4, a bounding box is generated, which encloses the part of the transport item or the transport item. The bounding box can be generated using the analyzed data elements. As such, after analyzing the data elements, it is known whether this contains a part of the transport item.

In a fifth method step S5, the output signal is transmitted from the transport item recognition module 4 to the trigger module 5. In the trigger module 5, a capture time is determined on the basis of the output signal from the transport item recognition module 4. In addition, a period of time is determined in the trigger module 5 with regard to the time at which the transport item 1 is arranged in the monitoring area 2 in its entirety.

Based on the outputs of the transport item recognition module 4 and/or the trigger module 5, a capture signal is generated and transmitted to the image acquisition device 5. The capture signal can contain the information that the image acquisition device 5 is to capture an image and the information as to when this is to take place.

In the sixth method step S6, the image acquisition device 10 captures the image of the monitoring area 2 and stores it. An assessment of the transport item quality, which is not presented in more detail here, can be performed on the basis of the captured image.

### LIST OF REFERENCE SYMBOLS

1 Predetermined transport item
1a Other transport item
2 Monitoring area
3 Computing device
4 Transport item recognition module
5 Trigger module
6 Filter module
7 Artificial neural network
8 Input layer
9 Device
10 Image acquisition device
11 Conveyor belt
12 Housing
13 Capture signal
14 Control signal
15 Input layer
16 Decision layer
17 First layer
17′ Second layer
18 Output of the unsupervised learning algorithm of the neural network
19 Other artificial neural network
20 Input layer of the other neural network
21 Further layer of the other neural network
22 Decision layer of the other neural network
23 Output of the unsupervised learning algorithm of the other neural network
H Height direction
W Width direction
D Depth direction
C1 First cluster range
C2 Second cluster range
E1 First expected value range
E2 Second expected value range
V1 First variance range
V2 Second variance range
S1-S6 Method steps

1.-31. (canceled)

32. A method for determining whether at least one predetermined transport item is arranged in a monitoring area, comprising:
acquiring an image signal of the monitoring area through which a transport path of an object passes is acquired;
supplying the image signal to an artificial neural network, wherein before supplying the image signal to the artificial neural network, it is determined by another artificial neural network based on the image signal whether at least one part of an object is arranged in the monitoring area, wherein the image signal is supplied to the artificial neural network when it is determined by the other artificial neural network that at least a part of the object is arranged in the monitoring area;
determining by the artificial neural network based on the image signal whether the at least one part of the object corresponds to at least a part of the at least one predetermined transport item; and
generating an image of the monitoring area when it is determined by the artificial neural network that at least a part of the at least one predetermined transport item is arranged in the monitoring area.

33. The method according to claim 32, wherein the artificial neural network has a convolutional neural network, wherein:
a. the image signal is supplied to an input layer of the convolutional neural network; and/or
b. a number of neurons of an input layer of the convolutional neural network corresponds to a number of pixels of the image signal; and/or
c. an input layer of the convolutional neural network is three-dimensional.

34. The method according to claim 33, wherein:
a. the artificial neural network has at least one layer, wherein the at least one layer is a neural convolutional layer, and/or wherein the at least one layer is connected to the input layer and/or receives output data from the input layer; and/or
b. the convolutional neural network has multiple layers, each having one or more sub-layers, wherein a first layer follows the input layer and is generated by applying at least one filter, and/or wherein a first layer and a second layer following the first layer are present, wherein the second layer is generated by applying at least one filter.

35. The method according to claim 33, wherein:
a. the convolutional neural network has a decision layer and multiple preceding layers, wherein the decision layer is connected to at least two layers; and/or
b. a decision layer of the convolutional neural network has an unsupervised learning algorithm and the decision layer is fully connected to a preceding layer; and/or
c. the convolutional neural network has a decision layer and an input layer, wherein the decision layer is connected to the input layer.

36. The method according to claim 32, wherein:
a. the artificial neural network has an unsupervised learning algorithm; and/or
b. a decision layer of the artificial neural network has the unsupervised learning algorithm.

37. The method according to claim 32, wherein a data element of the image signal supplied to a decision layer is evaluated to determine whether it contains a part of the predetermined transport item, wherein the evaluation comprises determining at least one parameter, wherein by using the determined at least one parameter it is determined whether the data element contains a part of the predetermined transport item.

38. The method according to claim 37, wherein:
a. an unsupervised learning algorithm uses a training result of the artificial neural network in order to determine whether the data element of the image signal contains a part of the predetermined transport item; and/or
b. the unsupervised learning algorithm determines that the supplied data element contains a part of the predetermined transport item if the determined at least one parameter is within at least one pre-trained parameter range.

39. The method according to claim 38, wherein:
a. the unsupervised learning algorithm is configured such that it outputs a bounding box as an output, which encloses at least a part of the predetermined transport item; and/or
b. the unsupervised learning algorithm generates a bounding box when it is determined that a part of the predetermined transport item is arranged in the monitoring area.

40. The method according to claim 32, wherein:
a. a capture time for generating the image is determined; and/or
b. a capture time for generating the image is determined, wherein the capture time is offset by a period of time from a determination time at which the other artificial neural network has determined that at least a part of the object is arranged in the monitoring area; and/or
c. a capture time is offset by a period of time from a determination time at which the artificial neural network has determined that the object is arranged in the monitoring area, wherein the period of time is selected such that the entire object is arranged in the monitoring area at the capture time.

41. The method according to claim 32, wherein:
a. a transport item quality is assessed based on the generated image; and/or
b. the other neural network has another convolutional neural network; or
c. the other neural network has another convolutional neural network, which has fewer layers than a convolutional neural network of the artificial neural network.

42. The method according to claim 32, wherein a decision layer of the other artificial neural network has another unsupervised learning algorithm, wherein:
a. the other unsupervised learning algorithm uses a training result of the other artificial neural network to determine whether a data element of the image signal contains a part of the object; and/or
b. the other unsupervised learning algorithm determines another parameter based on the image signal, and the other unsupervised learning algorithm determines whether at least a part of the object is arranged in the monitoring area depending on the other parameter.

43. The method according to claim 32, wherein:
a. a training of the artificial neural network has a first training phase and a second training phase; and/or
b. a training of the artificial neural network has a first training phase and a second training phase, wherein the training of the artificial neural network in the second training phase is carried out using the artificial neural network trained in the first training phase.

44. The method according to claim 43, wherein in the first training phase:
a. the artificial neural network to be trained has another decision layer; and/or
b. a decision layer of the artificial neural network to be trained does not have an unsupervised learning algorithm; and/or
c. a number of training images supplied to the artificial neural network to be trained in the first training phase is greater than a number of images supplied to the artificial neural network to be trained in the second training phase; and/or
d. the images supplied to the artificial neural network to be trained in the first training phase are labeled; and/or
e. the images supplied to the artificial neural network to be trained in the first training phase contain the predetermined transport item.

45. The method according to claim 43, wherein:
a. in the second training phase, a decision layer of the artificial neural network to be trained has an unsupervised learning algorithm; and/or
b. in the second training phase, training images without labeling are supplied to the artificial neural network; and/or
c. in the second training phase, the artificial neural network to be trained is supplied with training images which contain the predetermined transport item and/or training images which do not contain the predetermined transport item.

46. The method according to claim 43, wherein at least one parameter is determined for a training data element of a training image supplied to a decision layer.

47. The method according to claim 46, wherein:
a. a variance and/or an expected value of image information contained in the training data element of a training image is determined; and/or
b. at least one parameter range is determined for the training images supplied in the second training phase, taking into account the at least one determined parameter, in which at least one training data element has a part of the transport object.

48. The method according to claim 32, wherein, for training the other neural network, training images are supplied which contain different objects, and/or which contain objects which are different from the predetermined transport item, and wherein for a training image supplied to a decision layer of the other neural network, at least one other parameter is determined which characterizes whether the training image has at least a part of the predetermined transport item.

49. A computing device configured to determine whether at least one predetermined transport item is arranged in a monitoring area, comprising:
a transport item recognition module, which has an artificial neural network, and a filter module, which has another artificial neural network and is connected upstream of the transport item recognition module;
wherein the computing device is configured such that the other artificial neural network of the filter module determines whether at least a part of an object is arranged in the monitoring area based on an image signal, wherein the image signal is supplied to the artificial neural network of the transport item recognition module when the other artificial neural network determines that at least one part of the object is arranged in the monitoring area, and that the artificial neural network determines based on the image signal whether the determined at least one part of the object corresponds to at least a part of the at least one predetermined transport item; and wherein
the computing device causes an image of the monitoring area to be generated when the artificial neural network determines that at least a part of the at least one predetermined transport item is arranged in the monitoring area.

50. A device having an image acquisition device for acquiring an image signal which originates from a monitoring area, and a computing device according to claim 49 which is connected to the image acquisition device in terms of data transmission and to which the acquired image signal is supplied, wherein the image acquisition device captures the image after receiving a capture signal output by the computing device.

51. A computer program product comprising instructions which, when the program is executed by a computing device, cause it to carry out the method according to claim 32.
